(19) United States
(12) Patent Application Publication
(10) Pub. No.: US 2023/0408036 A1
(43) Pub. Date: Dec. 21, 2023

(54) METHOD FOR OPERATING A CRYOGENIC REFUELING ARRANGEMENT

(71) Applicants: Linde GmbH, Pullach (DE); Butting Cryo Tech GmbH, Burgkirchen (DE)

(72) Inventors: Florian EHEGARTNER, Pullach (DE); Peter GERSTL, Pullach (DE); Bernhard REITER, Grabenstätt (DE)

(21) Appl. No.: 18/247,696

(22) PCT Filed: Oct. 1, 2021
(86) PCT No.: PCT/EP2021/025375

§ 371 Date: Apr. 3, 2023

(30) Foreign Application Priority Data
Oct. 2, 2020 (EP) 20020448.5

(51) Int. Cl. F17C 13/04

(52) U.S. Cl. CPC F17C 13/04; F17C 2205/0323; F17C 2205/037; F17C 2223/0161; F17C 2265/065

(57) ABSTRACT

A method for operating a cryogenic refueling arrangement comprising a coupling device and a receiver socket, wherein the method comprises the following steps: a) coupling the coupling device to the receiver socket such that the coupling device and the receiver socket are locked to one another in a first position, b) applying a negative pressure to the coupling device and/or the receiver socket, c) unlocking the coupling device and the receiver socket so that the negative pressure causes the coupling device to move, in a direction toward the receiver socket, from the first position into a second position, which is different from the first position, d) locking the coupling device and the receiver socket in the second position, and e) starting a refueling process.

The invention relates to a method for operating a cryogenic refueling arrangement.

A storage container, for example of a vehicle, can be refueled with a cryogen by means of what is known as a cryogenic refueling installation or cryogenic refueling arrangement. The cryogen can be, for example, liquid hydrogen. The refueling process requires a number of steps to be carried out manually. In particular, pre- and post-preparation processes before or after the actual refueling process can take a long time. This makes the refueling process very complex. Furthermore, the refueling process can also be carried out only by specially trained personnel.

Against this background, an object of the present invention is to provide an improved method for operating a cryogenic refueling arrangement.

Accordingly, a method for operating a cryogenic refueling arrangement comprising a coupling device and a receiver socket is proposed. The method comprises the following steps: a) coupling the coupling device to the receiver socket such that the coupling device and the receiver socket are locked to one another in a first position, b) applying a negative pressure to the coupling device and/or the receiver socket, c) unlocking the coupling device and the receiver socket so that the negative pressure causes the coupling device to move, in a direction toward the receiver socket, from the first position into a second position, which is different from the first position, d) locking the coupling device and the receiver socket in the second position, and e) starting a refueling process.

Due to the fact that the coupling device is moved from the first position into the second position by means of the negative pressure, the method can be carried out in an automated manner. This enables very short cycle times, high flow rates and a very high level of safety for the operator and the method per se.

In order to couple the coupling device to the receiver socket, the coupling device can be inserted into the receiver socket. By means of a sensor or switch, it is possible to check whether the coupling device and the receiver socket are in the first position and can thus be locked to one another. A first engagement element associated with the receiver socket can be assigned to locking the coupling device in the first position, which engagement element can form-fittingly engage in a first counter-engagement element associated with the coupling device in order to lock the coupling device and the receiver socket.

To generate the negative pressure, or a vacuum, the cryogenic refueling arrangement can have a vacuum pump. In the present context “applying a negative pressure” is understood to mean that a volume associated with the coupling device and/or the receiver socket, or a cavity, is evacuated by means of the vacuum pump. The unlocking is automated by disengaging the first engagement element from the first counter-engagement element. After unlocking, the coupling device is pulled into the receiver socket by the negative pressure such that the coupling device is moved into the second position. Whether the coupling device is in the second position can be queried, for example, by means of a sensor, a switch or the like.

A second engagement element associated with the coupling device is assigned to locking the coupling device and the receiver socket in the second position, which engagement element can form-fittingly engage in a second counter-engagement element associated with the receiver socket in order to lock the coupling device and the receiver socket in the second position. After starting the refueling process, the cryogen flows through the cryogenic refueling arrangement.

According to one embodiment, a pressure hold test is carried out prior to step e).

This allows leakages to be detected.

According to a further embodiment, during step b), the negative pressure is applied to a volume provided between a shut-off valve of the coupling device and a shut-off valve of the receiver socket.

The shut-off valves are situated opposite one another. The shut-off valves can be designed as lids, slides or the like.

According to a further embodiment, the shut-off valves are opened prior to step c).

As a result, volumes associated with the coupling device and with the receiver socket are connected to one another.

According to a further embodiment, during step b), the negative pressure is applied to a volume enclosed by a housing of the receiver socket.

The coupling device is also associated with a housing which encloses a volume associated with the coupling device.

According to a further embodiment, steps a) to e) are carried out in an automated manner by means of a control device of the cryogenic refueling arrangement.

For example, the control device controls the vacuum pump and the engagement elements. The engagement elements can be movably mounted and can be moved by an actuator.

According to a further embodiment, prior or to or in step e), a main valve of the coupling device and a user valve of the receiver socket are opened.

For example, the user can manually open the user valve.

According to a further embodiment, during step c), a coupling of the coupling device is coupled to a coupling of the receiver socket.

For example, the receiver socket has a female coupling and the coupling device has a corresponding male coupling.

According to a further embodiment, after step e), an air relief valve of the coupling device is opened in order to carry out alternating pressure flushing of the couplings.

In this way, for example, humid ambient air can be expelled. This allows icing up of the cryogenic refueling arrangement to be reliably prevented.

According to a further embodiment, the coupling device and/or the receiver socket are relieved of the negative pressure after the alternating pressure flushing.

This can be done, for example, by venting the coupling device and/or the receiver socket.

According to a further embodiment, the coupling device and the receiver socket are unlocked in the second position after being relieved of the negative pressure.

For this purpose, the second engagement element can be disengaged from the second counter-engagement element.

According to a further embodiment, an overpressure is applied to the coupling device and/or the receiver socket after the unlocking, so that the overpressure causes the coupling device to move, in a direction away from the receiver socket, from the second position into the first position.

The overpressure can be generated, for example, by means of evaporated cryogen.

According to a further embodiment, the coupling device and the receiver socket are locked in the first position.

For this purpose, the first engagement element and the first counter-engagement element interlock.

According to a further embodiment, a shut-off valve of the coupling device and a shut-off valve of the receiver socket are closed.

The coupling device and the receiver socket can then be separated from one another.

According to a further embodiment, a cooling process is carried out prior to step e).

This is carried out using the cryogen.

In the present case, “a(n)” is not necessarily to be understood as limiting to exactly one element. It is rather the case that several elements, such as two, three, or more, may also be provided. Any other numerical word used herein is also not to be understood as meaning that an exact limitation to exactly the corresponding number of elements must be realized. Rather, numerical deviations upward or downward are possible.

Further possible implementations of the method also include not explicitly mentioned combinations of features or embodiments described above or below with respect to the exemplary embodiments. A person skilled in the art will also add individual aspects as improvements or additions to the relevant basic form of the method.

Further advantageous embodiments of the method are the subject matter of the dependent claims and of the exemplary embodiments of the method that are described below. The method is explained below in more detail on the basis of preferred embodiments and with reference to the enclosed drawings.

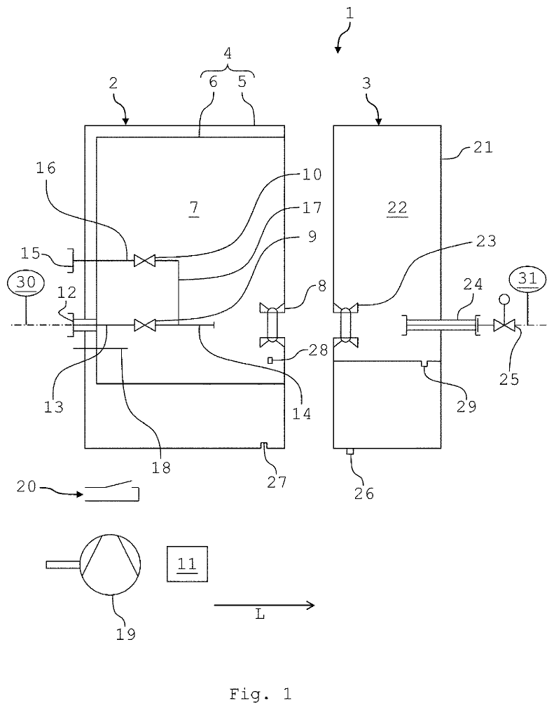

FIG. 1 is a schematic view of an embodiment of a cryogenic refueling arrangement;

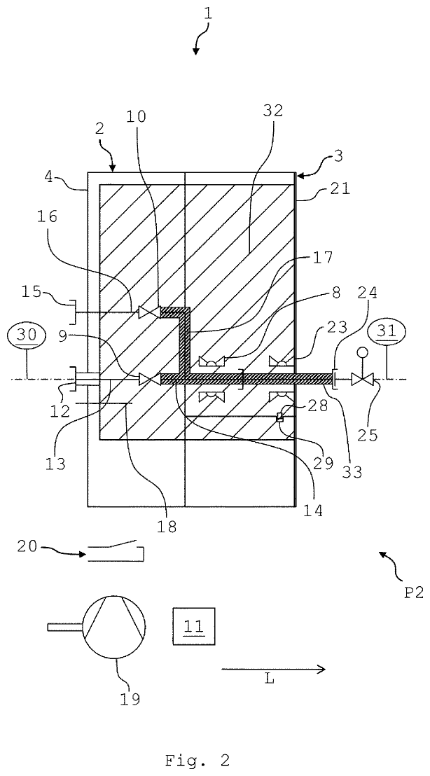

FIG. 2 is a further schematic view of the cryogenic refueling arrangement;

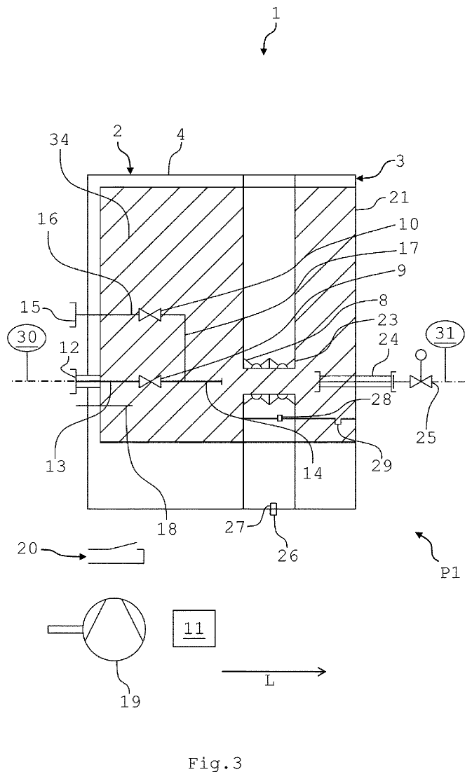

FIG. 3 is a further schematic view of the cryogenic refueling arrangement;

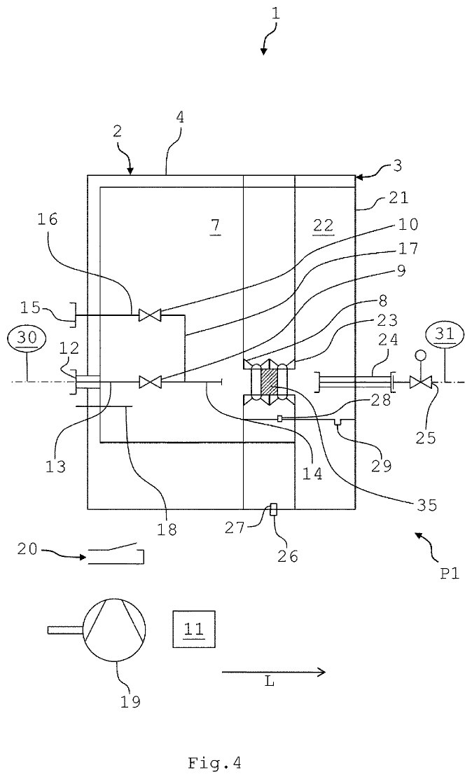

FIG. 4 is a further schematic view of the cryogenic refueling arrangement; and

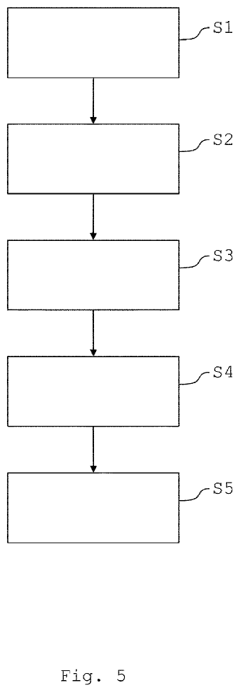

FIG. 5 is a schematic block diagram of an embodiment of a method for operating the cryogenic refueling arrangement according to FIG. 1.

In the drawings, the same or functionally equivalent elements have been provided with the same reference signs unless otherwise indicated.

FIG. 1 is a schematic view of a cryogenic refueling arrangement 1. The cryogenic refueling arrangement 1 comprises a coupling device 2 and a receiver socket 3 for receiving the coupling device 2. The receiver socket 3 can receive at least some portions of the coupling device 2. The coupling device 2 and the receiver socket 3 can be connected to one another and disconnected from one another again. The cryogenic refueling arrangement 1 is suitable for refueling a storage tank with a cryogen, for example. The cryogen can be, for example, liquid hydrogen, silane, ethylene or the like.

The coupling device 2 comprises a housing 4 having an outer or first wall 5 and an inner or second wall 6 accommodated in the first wall 5. The second wall 6 encloses a first volume 7. The coupling device 2 has a shut-off valve 8. The shut-off valve 8 allows fluidic access to the first volume 7. The shut-off valve 8 can be a valve, in particular an on/off valve. The shut-off valve 8 can be designed as an openable and closable flap, slide or the like.

The coupling device 2 has a main valve 9 and an air relief valve 10. The main valve 9 and the air relief valve 10 are preferably on/off valves. The main valve 9, the air relief valve 10 and the shut-off valve 8 can be controlled by means of a control device 11. The main valve 9 and the air relief valve 10 can preferably be controlled in an automated manner.

A line 13 leads from a coupling 12 to the main valve 9. At least some portions of the coupling 12 can be situated outside the housing 4. The coupling 12 is in particular vacuum-insulated. A male coupling 14 leads away from the main valve 9. A line 16 leads from a coupling 15 to the air relief valve 10. Another line 17 leads away from the air relief valve 10 and opens into the coupling 14.

The first volume 7 is accessible via a line 18. For example, the first volume 7 can be relieved or evacuated via the line 18. For this purpose, a vacuum pump 19 can be associated with the coupling device 2. Furthermore, a start/stop button 20 can also be associated with the coupling device 2. Using the start/stop button 20, a refueling process can be started and stopped.

Returning to the receiver socket 3, this socket comprises a housing 21 which encloses a third volume 22. Furthermore, a second volume is also provided, which will be discussed below. A shut-off valve 23 is associated with the receiver socket 3. The shut-off valves 8, 23 can be situated opposite one another. The receiver socket 3 furthermore comprises a vacuum-insulated coupling 24 and a user valve 25. The user valve 25 can be opened and closed by a user.

The receiver socket 3 comprises a first engagement element 26 which can form-fittingly engage in a first counter-engagement element 27 of the coupling device 2. That is to say that the coupling device 2 can be locked to the receiver socket 3. For example, the first engagement element 26 can be movably mounted so that it can be brought into and out of engagement with the first counter-engagement element 27. The first engagement element 26 can be actuated pneumatically or hydraulically, for example. As soon as the first engagement element 26 and the first counter-engagement element 27 interlock, the coupling device 2 and the receiver socket 3 are in a first position.

The coupling device 2 further comprises a second engagement element 28, which is suitable for engaging in a corresponding second counter-engagement element 29 of the receiver socket 3. For example, the second engagement element 28 can be movably mounted so that it can be brought into and out of engagement with the second counter-engagement element 29. The second engagement element 28 can be actuated pneumatically or hydraulically, for example. As soon as the second engagement element 28 and the second counter-engagement element 29 interlock, the coupling device 2 and the receiver socket 3 are in a second position, which is different from the first position. In the second position, the coupling device 2 is pushed further into the receiver socket 3 than in the first position, as viewed in a longitudinal direction L of the cryogenic refueling arrangement 1. A first temperature-measuring point 30 is located upstream of the coupling 12. A second temperature measuring point 31 is located downstream of the coupling 24.

The functionality of the cryogenic refueling arrangement 1 is explained below. Firstly, the cryogenic refueling arrangement 1 is in an initial state, which is shown in FIG. 2. In the initial state, the coupling device 2 is locked in a parking station in the aforementioned second position P2. This means that the second engagement element 28 and the second counter-engagement element 29 are interlocking. The main valve 9 is closed. The air relief valve 10 is open. The user valve 25 is closed. The pressure and temperature in a fifth volume 32 (hatched) and in a sixth volume 33 (hatched) are undefined. Furthermore, a fourth volume is provided, which will be explained below. The sixth volume 33 is provided in coupling 14, the line 17 and coupling 24.

This is followed by a cooling process. The start of the cooling process is automated. Alternating pressure flushing of the fifth volume 32 takes place. Thereafter, the fifth volume 32 is evacuated via the line 18 and a vacuum hold test is carried out. If the vacuum hold test is positive, the process is continued. In the case of a negative vacuum hold test, the process is stopped and an error routine is performed. The air relief valve 10 is opened. Alternating pressure flushing of the sixth volume 33 and a pressure hold test take place. If the pressure hold test is positive, the process is continued. In the case of a negative pressure hold test, the process is stopped and an error routine is performed.

The transfer of the cryogen can begin to start as soon as the temperature at the second temperature measuring point 31 corresponds to the temperature at the first temperature measuring point 30 plus 10 K. The main valve 9 is open. The air relief valve 10 is closed. The user valve 25 is open. The fifth volume 32 is evacuated. The sixth volume 33 is pressureless and cold. The temperature in the sixth volume 33 corresponds to the temperature at the second temperature measuring point 31. The cooling process is completed as soon as the target temperature is reached at the second temperature measuring point 31.

FIG. 3 shows the cryogenic refueling arrangement 1 after the cooling process, after the end of a refueling process or after an emergency disconnection by the user. Firstly, the transfer of the cryogen is stopped. This is followed by a sub-process for enabling the coupling device 2 and the receiver socket 3 to unlock. If the unlocking is enabled, the process is continued. If it is not enabled, the process is stopped and an error routine is performed. Alternating pressure flushing of the sixth volume 33 takes place via the coupling 15. Subsequently, the air relief valve 10 is closed.

The vacuum in the fifth volume 32 is relieved via the line 18. The second position P2 is unlocked, which means that the second engagement element 28 is disengaged from the second counter-engagement element 29. The fifth volume 32 is pressurized with gaseous cryogen via the line 18, causing the coupling device 2 and the receiver socket 3 to move away from one another. The shut-off valves 8, 23 are still open, and therefore the volumes 7, 22 are in fluid connection with one another and form a common fourth volume 34.

The pressure in the fourth volume 34 is slowly increased until the coupling device 2 is in the first position P1 and can be locked therein by means of the first engagement element 26 and the first counter-engagement element 27. After locking in the first position P1, the fourth volume 34 is relieved via the line 18 to 1.2 bara, for example. The main valve 9 is closed. The unlocking and the pneumatic ejection are completed when a switch or sensor associated with the first engagement element 26 and with the first counter-engagement element 27 outputs the information that the first engagement element 26 and the first counter-engagement element 27 are locked to one another.

In the following, as shown in FIG. 4, the shut-off valves 8, 23 are closed. The closing can be triggered by an automatic control system or by the start/stop button 20. A second volume 35 is provided between the closed shut-off valves 8, 23. The coupling device 2 and the receiver socket 3 are still locked in the first position P1. After the first engagement element 26 and the first counter-engagement element 27 have been unlocked, the coupling device 2 can be decoupled from the receiver socket.

To couple the coupling device 2 to the receiver socket 3, the coupling process is started by means of the start/stop button 20. A check is then made as to whether the coupling device 2 is accommodated in the receiver socket in such a way that the first engagement element 26 can engage in the first counter-engagement element 27. If this is the case, the coupling device 2 and the receiver socket 3 are locked to one another in the first position P1. The third volume 22 and the second volume 35 are evacuated. The vacuum in the third volume 22 is checked. Subsequently, the shut-off valves 8, 23 are opened.

The first position P1 is unlocked, which means that the first engagement element 26 and the first counter-engagement element 27 are no longer interlocked. The vacuum pulls the coupling device 2 into the second position P2. A check is made as to whether the coupling device 2 is placed relative to the receiver socket 3 in such a way that the second engagement element 28 and the second counter-engagement element 29 can interlock. If this is the case, the coupling device 2 is locked in the second position P2. A pressure hold test and clearance space scavenging take place. A stop or termination of the coupling process can be indicated via a display or the like.

After coupling, a refueling process can be carried out. The refueling process can be triggered automatically or by means of the start/stop button 20. The triggering can be displayed via the above-mentioned display. The transfer of the cryogen can only be started and stopped. The stop can be displayed, for example, by means of the display or the like.

FIG. 5 is a schematic block diagram of an embodiment of a method for operating the cryogenic refueling arrangement 1. In the method, in a step S1 the coupling device 2 is coupled to the receiver socket 3 such that the coupling device 2 and the receiver socket 3 are locked to one another in the first position P1. In a step S2 a negative pressure is applied to the coupling device 2 and/or the receiver socket 3.

After this, in a step S3 the coupling device 2 and the receiver socket 3 are unlocked so that the negative pressure causes the coupling device 2 to move, in a direction toward the receiver socket 3, from the first position P1 into the second position P2, which is different from the first position P1. In a step S4 the coupling device 2 and the receiver socket 3 are locked in the second position P2. After this, the refueling process can be started in a step S5.

Although the present invention has been described with reference to exemplary embodiments, it can be modified in many ways.

### REFERENCE SIGNS USED

1 Cryogenic refueling arrangement
2 Coupling device
3 Receiver socket
4 Housing
5 Wall
6 Wall
7 Volume
8 Shut-off valve
9 Main valve
10 Air relief valve
11 Control device
12 Coupling
13 Line
14 Coupling
15 Coupling
16 Line
17 Line
18 Line
19 Vacuum pump
20 Start/stop button
21 Housing
22 Volume
23 Shut-off valve
24 Coupling
25 User valve
26 Engagement element
27 Counter-engagement element
28 Engagement element
29 Counter-engagement element
30 Temperature measuring point
31 Temperature measuring point
32 Volume
33 Volume
34 Volume
35 Volume
L Longitudinal direction
P1 Position
P2 Position
S1 Step
S2 Step
S3 Step
S4 Step
S5 Step

1. A method for operating a cryogenic refueling arrangement comprising a coupling device and a receiver socket, wherein the method comprises the following steps:
a) coupling the coupling device to the receiver socket such that the coupling device and the receiver socket are locked to one another in a first position,
b) applying a negative pressure to the coupling device and/or the receiver socket,
c) unlocking the coupling device and the receiver socket so that the negative pressure causes the coupling device to move, in a direction toward the receiver socket, from the first position into a second position, which is different from the first position,
d) locking the coupling device and the receiver socket in the second position, and
e) starting a refueling process.

2. The method according to claim 1, wherein a pressure hold test is carried out prior to step e).

3. The method according to either claim 1, wherein, during step b), the negative pressure is applied to a volume provided between a shut-off valve of the coupling device and a shut-off valve of the receiver socket.

4. The method according to claim 3, wherein the shut-off valves are opened prior to step c).

5. The method according to claim 1, wherein, during step b), the negative pressure is applied to a volume enclosed by a housing of the receiver socket.

6. The method according to claim 1, wherein steps a) to e) are carried out in an automated manner by means of a control device of the cryogenic refueling arrangement.

7. The method according to claim 1, wherein, prior to or in step e), a main valve of the coupling device and a user valve of the receiver socket are opened.

8. The method according to claim 1, wherein, during step c), a coupling of the coupling device is coupled to a coupling of the receiver socket.

9. The method according to claim 8, wherein, after step e), an air relief valve of the coupling device is opened in order to carry out alternating pressure flushing of the couplings.

10. The method according to claim 9, wherein the coupling device and/or the receiver socket are relieved of the negative pressure after the alternating pressure flushing.

11. The method according to claim 10, wherein the coupling device and the receiver socket are unlocked in the second position after being relieved of the negative pressure.

12. The method according to claim 11, wherein an overpressure is applied to the coupling device and/or the receiver socket after the unlocking, so that the overpressure causes the coupling device to move, in a direction away from the receiver socket, from the second position into the first position.

13. The method according to claim 12, wherein the coupling device and the receiver socket are locked in the first position.

14. The method according to claim 13, wherein a shut-off valve of the coupling device and a shut-off valve of the receiver socket are closed.

15. The method according to claim 1, wherein a cooling process is carried out prior to step e).
